(19) United States
(12) Patent Application Publication
(10) Pub. No.: US 2012/0114158 A1
(43) Pub. Date: May 10, 2012

(54) HEARING ASSISTANCE SYSTEM

(75) Inventor: Stefan Gysin, Bern (CH)

(73) Assignee: PHONAK AG, Staefa (CH)

(21) Appl. No.: 13/383,428

(22) PCT Filed: Jul. 20, 2009
(86) PCT No.: PCT/EP2009/059306

§ 371 Date: Jan. 11, 2012

(51) Int. Cl. H04R 25/00

(52) U.S. Cl. 381/315

(57) ABSTRACT

A hearing assistance system having a transmission unit (10, 10′) with a microphone arrangement (16) for capturing audio signals from a speaker's voice and means (20, 22) for transmitting audio signals via a wireless audio link (24); at least one receiver unit (12) for receiving audio signals from the transmission unit via the wireless audio link, the receiver unit having a speech quality indicator unit (40) for assessing the speech quality of the received audio signals and for providing an signal representative of the assessed speech quality; an arrangement (38) for stimulating a user's hearing according to the audio signals received by the receiver unit; and an arrangement (40) for providing an alarm signal if the assessed speech quality is below a predefined threshold value.

### BACKGROUND OF THE INVENTION

1. Field of the Invention

The invention relates to a wireless hearing assistance system comprising a transmission unit including a microphone arrangement for capturing audio signals from a speaker's voice and means for transmitting audio signals via a wireless audio link, a receiver unit for receiving audio signals via the wireless audio link and means for stimulating a user's hearing according to the audio signals received by the receiver unit.

2. Description of Related Art

The stimulating means may be part of a hearing aid, with the receiver unit being connected to or integrated within the hearing aid (according to another typical application, the stimulating means may be a loudspeaker which is part of the receiver unit or is connected thereto; such systems are particularly helpful in teaching environments for normal-hearing children suffering from auditory processing disorders (APD)). In general, wireless hearing assistance systems (also labeled as assistive listening systems (ALS)) are used not only in schools but also in other public areas like theaters, cinemas and auditoriums, where a speaker using a microphone speaks to an audience including hearing-impaired persons. The audio signals captured from the speaker's voice are then transmitted from the microphone to the hearing aids of the hearing-impaired persons via a wireless link, which typically is a FM (Frequency Modulation) link, but also may be a IR (Infrared)-link, a 2.4 GHz digital link or an inductive loop.

A problem encountered with such wireless hearing assistance systems is the missing feedback to the speaking person about the quality of the sound that reaches the listener. Sound quality may be deteriorated by an inadequate placement of the microphone and/or interference problems of the wireless link. In this regard it is a further issue that many hearing-impaired people have problems in rating the quality of the perceived sound.

European Patent Application EP 1 638 367 A2 relates to a wireless hearing assistance system, wherein the transmission unit, upon request by the speaker, may send a polling command to the receiver unit in order to receive status information concerning the quality of the audio link, which status information may be displayed to the speaker.

European Patent Application EP 0 678 230 B1 and corresponding U.S. Pat. No. 5,471,650 relate to a mobile phone system, wherein the audio signal transmitted from the mobile phone to a base station is analyzed at the base station with regard to the quality of the wireless link, wherein the base station sends back to the mobile phone a signal indicative of the quality of the received signal. The quality indicator signal may be in the form of digital code or a processed side tone which is presented to the user via the speaker of the mobile phone, so that the user can hear a degraded side tone which corresponds to the quality of the wireless link as monitored at the base station.

U.S. Patent Application Publication US 2004/0059578 A1 relates to an aircraft speech transmission system, wherein the audio signal captured by a microphone is amplified and is supplied via cables to the cabin loudspeakers and wherein the microphone is provided with a speech quality analysis unit, which may indicate an unacceptable speech quality to the person using the microphone, so that the speaker may improve the volume and clarity of the speech, as well as the position and orientation of the microphone relative to the speaker's mouth.

### SUMMARY OF THE INVENTION

It is an object of the invention to provide for a wireless hearing assistance system, wherein the quality of the speech supplied to the listener should be optimized.

### Summary of the Invention

According to the invention, this object is achieved by hearing assistance systems as described herein. The invention is beneficial in that, by providing the system with a speech quality indicator unit for assessing the speech quality of the captured or received audio signals and for providing a signal representative of the assessed speech quality, a feedback regarding the quality of the speech presented to the listener may be provided to the speaker so that the speaker may act to improve the speech quality, for example, by correcting the microphone position and/or the speech volume or by changing parameters, such as the channel frequency, of the wireless audio link.

According to a first aspect of the invention, the speech quality indicator unit is provided as part of the receiver unit. In this case, the user of the hearing instrument is informed directly regarding the speech quality so that he may contact the speaker if the speech quality is poor. However, this solution is particularly useful, if the receiver unit is provided with a back channel so that the speaker or another person responsible for the quality of the transmitted speech (like a supervisor) may be informed directly by the receiver unit if the speech quality is poor. Since the audio signals as received by the receiver unit are analyzed, both inadequate audio signal capturing at the microphone arrangement and inadequate transmission via the audio link will be detected.

According to another aspect of the invention, the speech quality indicator unit is provided separate from the transmission unit and the receiver unit as part of stand-alone device. In this case, no modifications of the transmission unit or the receiver unit are necessary.

According to a further aspect of the invention, the speech quality indicator unit is provided as part of the transmission unit. In this case, the speaker is directly informed if the quality of the audio signals captured by the microphone arrangement is poor, with neither a modification to the receiver unit nor the provision of a separate stand-alone device being necessary. However, this solution does not allow poor transmission via the wireless audio link to be detected.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a block diagram of a first example of a hearing assistance system according to the invention, wherein the speech quality indicator unit is provided as part of the receiver unit;

FIG. 2 is a view like FIG. 1, wherein a modified embodiment is shown;

FIG. 3 is a view like FIG. 1 wherein a further modified embodiment is shown;

FIG. 4 is a block diagram of an example of a hearing assistance system according to the invention, wherein the speech quality indicator unit is provided as a separate device;

FIG. 5 is a schematic view of an example of the use of the hearing assistance system of FIG. 4; and

FIG. 6 is a block diagram of an example of a hearing assistance system according to the invention, wherein the speech quality indicator unit is provided as part of the transmission unit.

### DETAILED DESCRIPTION OF THE INVENTION

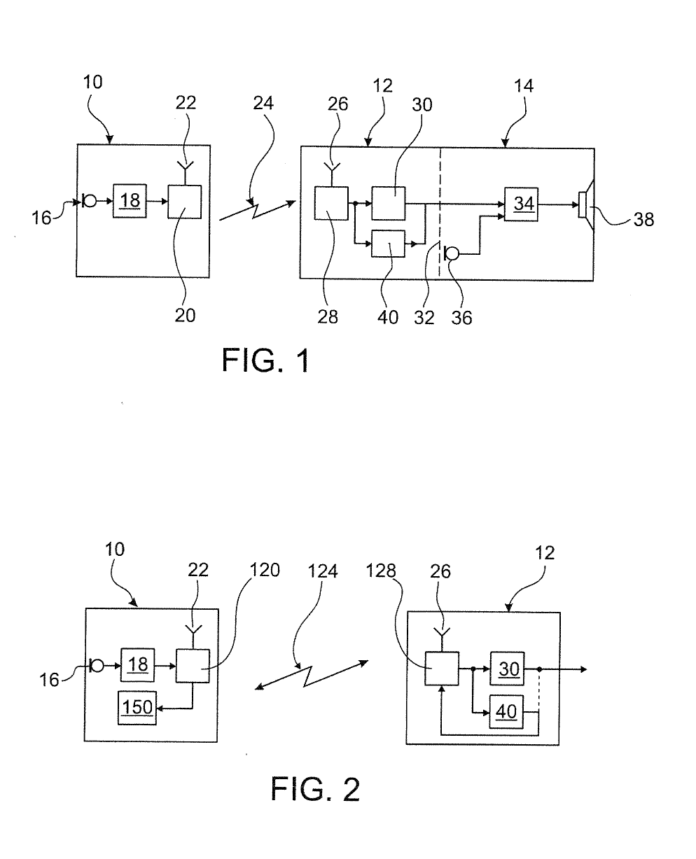

The hearing assistance system of FIG. 1 comprises a transmission unit 10, a receiver unit 12 and a hearing aid 14. The transmission unit 10 comprises a microphone arrangement 16 for capturing audio signals from a speaker's voice, an audio signal processing unit 18 for processing the audio signals captured by the microphone arrangement 16, a transmitter 20 and an antenna 22 for transmitting the audio signals processed by the audio signal processing unit 18 via a wireless link 24 to the receiver unit 12. The receiver unit 12 comprises an antenna 26, a receiver 28 and an audio signal processing unit 30 for processing the received audio signals. The receiver unit 12 is connected to the hearing aid 14 via an interface 32 which is usually a so-called “audio shoe”. The audio signals processed by the audio signal processing unit 30 are supplied as an input to an audio signal processing unit 34 of the hearing aid 14; in addition, the audio signals captured by a microphone arrangement 36 of the hearing aid 14 likewise are supplied as input to the audio signal processing unit 34. The audio signals processed by the audio signal processing unit 34 are supplied to an output transducer 38, typically a loudspeaker, of the hearing aid 14, in order to stimulate the user's hearing. Typically, both the microphone arrangement 16 of the transmission unit 10 and the microphone arrangement 36 of the hearing aid 14 comprise two spaced-apart microphones (not shown) in order to provide for acoustic beam forming. Typically, the wireless audio link 24 is an FM link. Rather than being connected to the hearing aid 14 as shown in FIG. 1, the receiver unit 12 may be integrated within the hearing aid 14.

The components described so far are standard equipment for wireless hearing assistance systems.

According to the example of FIG. 1, the receiver unit 12 is provided with a speech quality indicator unit 40 which assesses the speech quality of the audio signals received by the receiver 28 and provides for a signal representative of the assessed speech quality. Preferably, the speech quality indicator unit 40 provides for an alarm signal, if the assessed speech quality is below a predefined threshold value. According to the example of FIG. 1, the alarm signal provided by the speech quality indicator unit 40 is an audio signal which is mixed to the audio signals processed by the audio signal processing unit 30, so that the alarm signal is supplied, via the audio signal processing unit 34, to the output transducer 38. Thereby the user of the hearing aid 14 can be acoustically alerted if the quality of the received audio signals is poor. The user then may notify the speaker using the transmission unit 10 or another responsible person, such as a supervisor of the hearing assistance system.

In FIG. 2 a modified system is shown, wherein the transmitter 20 of the transmission unit 10 is replaced by a transceiver 120 and the receiver 128 of the receiver unit 12 is replaced by a transceiver 128 in order to realize a bidirectional (digital) wireless link 124 between the transmission unit 10 and the receiver unit 12—rather than an unidirectional analog wireless link 24 as in FIG. 1. Moreover, the alarm signal produced by the speech quality indicator unit 40 is supplied to the transceiver 128, in order to be transmitted to the transmission unit 10, which comprises an alarm unit 150 for supplying the received alarm signal to the speaker using the transmission unit 10. The alarm unit 150 may provide for an optical and/or acoustic signal corresponding to the alarm signal. The alarm signal may be transmitted via the wireless link 124 as an audio signal or as a digital code. In addition, as in the embodiment of FIG. 1, the alarm signal may be provided as an input to the hearing aid 14.

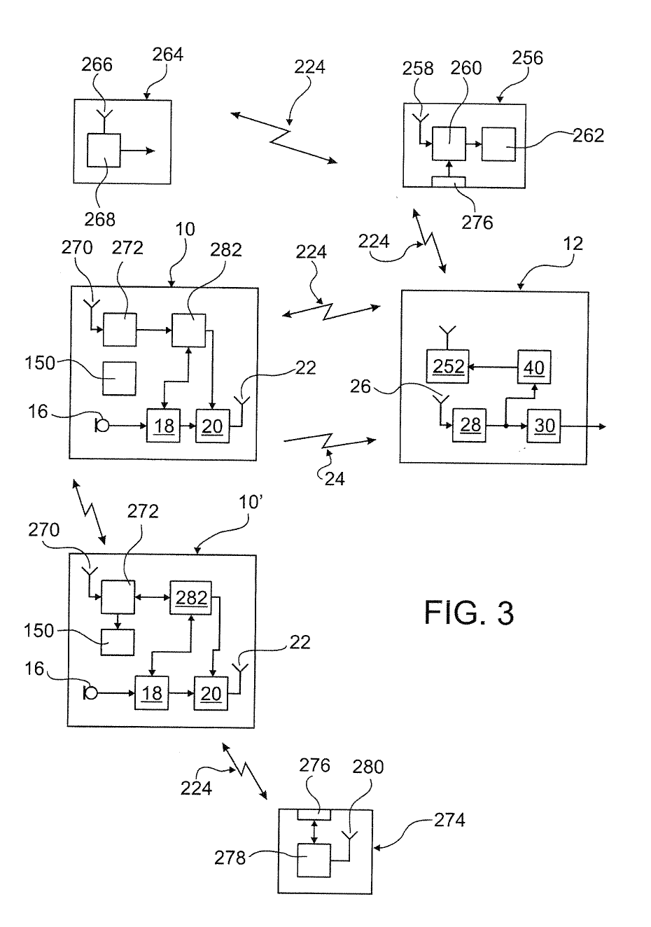

In FIG. 3 a modified embodiment of the system of FIG. 2 is shown, wherein there is a unidirectional analog wireless audio link 24 from the transmission unit 10 to the receiver unit 12, as in the embodiment of FIG. 1, and in addition there is a bidirectional digital data link 224 between the transmission unit 10 and the receiver unit 12.

The unilateral audio link 24 is realized by the transmitter 20, the antenna 22, the antenna 26 and the receiver 28 in order to transmit audio signals captured by the microphone arrangement 16 of the transmission unit 10 to the receiver unit 12.

The receiver unit 12 comprises a transceiver 252 and an antenna 254 in order to transmit the alarm signals generated by the speech quality indicator unit 40 via the data link 224 to the transmission unit 10 and/or other devices, such as a monitoring unit 256 to be used by a system supervisor, which comprises an antenna 258, a transceiver 260 and an alarm unit 262, which may provide the alarm signals optically and/or acoustically to the system supervisor. Alternatively or in addition, the alarm signals may be transmitted via the data link 224 to an interface 264 of a communication network, such as a WLAN system or an SMS system, with the interface 264 comprising an antenna 266 and a transceiver 268.

In the example of FIG. 3, the transmission unit 10 may be adapted to form part of a multi-talker communication network, which comprises a plurality of transmission units 10, 10′, each adapted to be worn by a different user and comprising a microphone arrangement 16 for capturing audio signals from the respective user's voice and a transmitter 20 and an antenna 22 for transmitting the captured audio signals via the audio link 24 to the receiver unit 12 or to a plurality of receiver units 12 worn by different listeners (of course, the same person may use one of the transmission units 10 and one of the receiver units 12 for acting both as a speaker and a listener).

To this end, each transmission unit 10, 10′ comprises an assistive digital link transceiver portion comprising an antenna 270 and a digital transceiver 272 for establishing a bidirectional assistive digital link 224 to at least one of the other transmission units 10, 10′ and/or to an external command unit 274 which comprises a user interface 276, a transceiver 278 and an antenna 280. Each transmission unit 10, 10′ further comprises a control unit 282 for controlling audio signal transmission of the transmission unit 10, 10′ via the audio link 24 according to data exchanged with the control unit 282 of one of the other transmission units 10, 10′ and/or with the command unit 274, wherein audio signal transmission of the transmission units 10, 10′ is controlled by communication of the control units 282 via the assistive digital link 224 in such a manner that at a time only one of the transmission units 10, 10′ is allowed to transmit audio signals via the audio link 24.

If the system is provided with such multi-talker communication network, examples of which are described in International Patent Application Publication WO 2008/074350 A1 and corresponding U.S. Patent Application Publication 2010/0135512, the assistive digital link 224 can be used by the receiver units 12 for transmitting the alarm signal provided by the speech quality indicator unit 40 to the transmission unit 10, 10′ and/or to the external devices 256, 264 and 274. In this case, the monitoring unit 256 may comprise a user interface 276 for also acting as an external command unit for the multi-talker communication network, so that the separate command unit 274 may be omitted.

The assistive digital link 224, which preferably uses the 2.45 GHz ISM band, may use GFSK as the modulation, and it may use frequency hopping for achieving reliable data transmission.

The transmission unit 10 of FIG. 3 may be provided with an alarm unit 150 for optically and/or acoustically presenting the alarm signal received via the assistive digital link 324 to the user of the respective transmission unit 10.

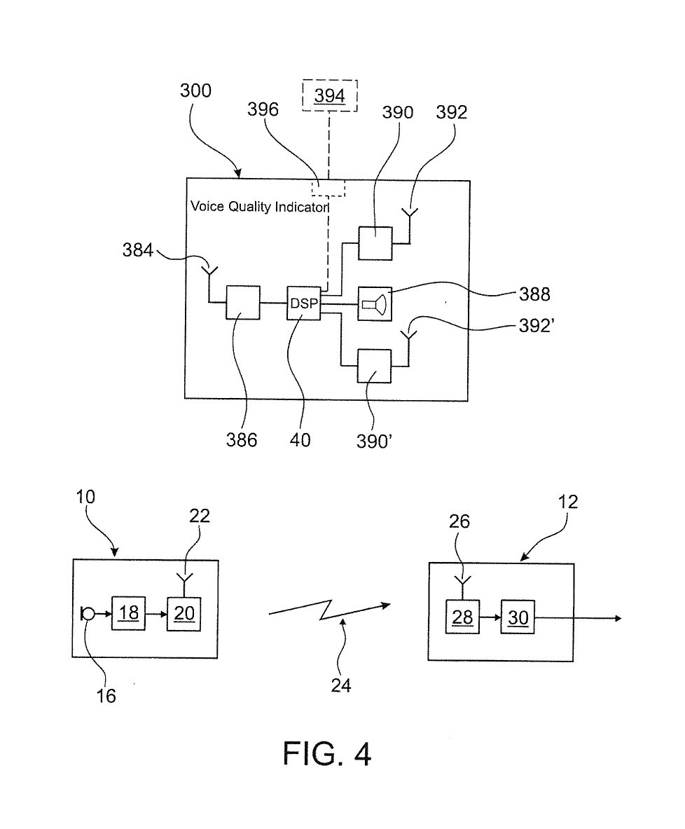

In FIG. 4, an example of a hearing assistance system is shown, wherein the speech quality indicator unit 40 is provided as part of a stand-alone speech quality indicator device 300, which, in addition to the speech quality indicator unit 40, comprises an antenna 384 and a receiver 386 for receiving the audio signal sent via the audio link 24 from the transmission unit 10 and an alarm unit 388 for providing the alarm signals of the speech quality indicator unit 40 optically and/or acoustically to a responsible person, such as a system supervisor. Alternatively or in addition, the indicator device 300 may comprise a transceiver 390 and an antenna 392 for transmitting the alarm signals of the speech quality indicator unit 40 via a data link 224 to an external device, such as a monitoring unit 256 or an interface 264 to a communication network. For example, the transceiver 390 may be adapted to send an SMS message to the mobile phone of a system supervisor. Alternatively or in addition, a transceiver 390′ and an antenna 392′ may be provided in the indicator device 300 for transmitting the alarm signals of the speech quality indicator unit 40 via a multi-talker communication network, as described with regard to FIG. 3.

According to an alternative embodiment (indicated in dashed lines in FIG. 4), the speech quality indicator device 300 may be adapted to communicate with a wire-based communication network 394, such as an analog telephone system (POTS), an ISDN-system, an ADSL-system or a LAN-system via an appropriate wire-base interface 396, for transmitting the alarm signal to a responsible person.

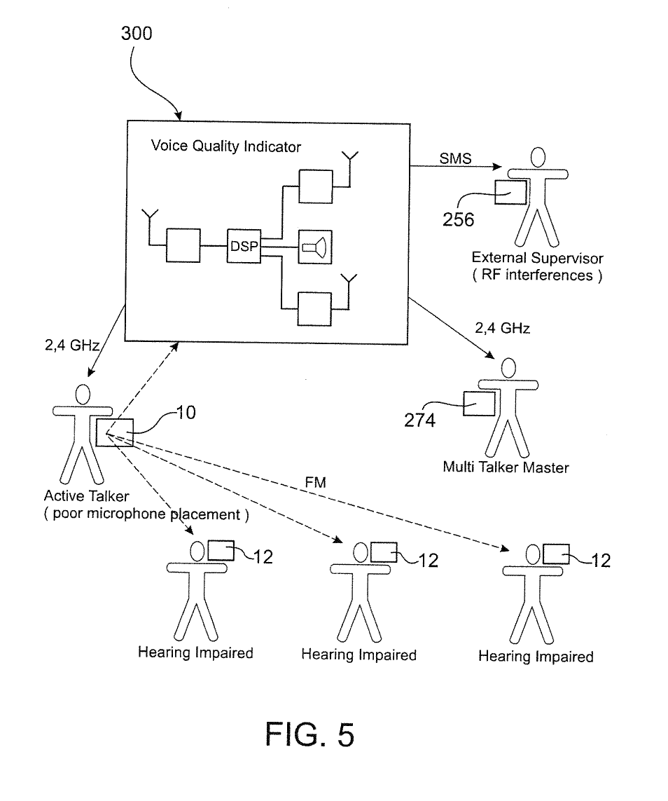

FIG. 5 is a schematic representation of how the indicator device 300 may be used in a hearing assistance system which comprises a transmission unit 10 used by the active talker, receiver units 12 used by hearing-impaired listeners, a multi-talker command unit 274 used by a multi-talker master and a monitoring unit 256 used by an external system supervisor.

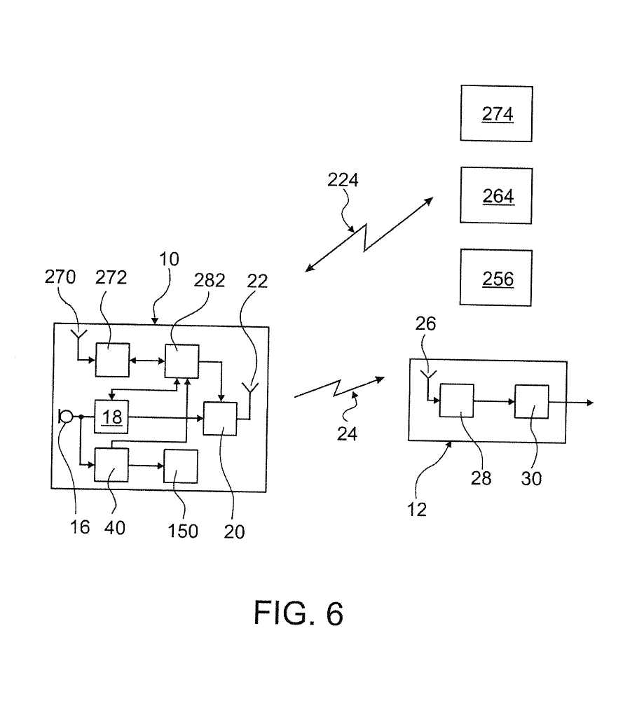

FIG. 6 shows an example of a hearing assistance system, wherein the speech quality indicator unit 40 is provided as part of a transmission unit 10 for analyzing the speech quality in the audio signals captured by the microphone arrangement 16 and for providing a respective feedback concerning speech quality to the speaker using the transmission unit 10, for example, by providing an acoustic and/optical alarm signal via an alarm unit 150 provided as part of the transmission unit 10, so that the speaker may correct the position of the microphone arrangement 16 relative to the speaker's mouth.

Alternatively or in addition, the transmission unit 10 may be adapted to transmit the alarm signal of the speech quality indicator unit 40 via a data link 224 to other devices, such as a multi-talker command unit 274, an external monitoring unit 256 or a communication network interface 264. Preferably, the transmission unit 10 in this case is designed as part of a multi-talker network, as described with regard to FIG. 3. In this case, the alarm signal from the speech quality indicator unit 40 is supplied to the control unit 282 in order to be transmitted via the transceiver 272 and the antenna 270.

In all embodiments, the alarm unit 150 of the transmission unit 10, in addition or alternatively to providing an optical or acoustic signal, may be capable of providing for a vibration signal to the speaker.

With regard to all embodiments, that the speech quality indicator unit 40 may not necessarily output an alarm signal; rather, it would be sufficient, if the output is a signal representative of the assessed speech quality. In this case, the alarm signal may be generated in the device receiving the signal representative of the assessed speech quality, with an alarm signal being generated in the external device, if the assessed speech quality is below a predefined threshold value, i.e., in this case the alarm signal actually would be generated in the device (such as the devices 256, 274 and 264 of FIG. 3) which receives the speech quality signal produced by the speech quality indicator unit 40.

In all embodiments in which a wireless communication network is involved in transmitting the alarm signal to a responsible person, the wireless communication network may be, for example, a WLAN, an SMS, a Bluetooth, a ZigBee, a DECT, a Certified Wireless USB or a ONE-NET system.

It is also noted that, in general, methods to be used in the speech quality indicator unit 40 for speech quality assessment are known in the art, for example, the ITU-T P.563 standard for single-ended speech quality assessment.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-26. (canceled)

27. A hearing assistance system comprising
a transmission unit comprising a microphone arrangement for capturing audio signals from a speaker's voice and means for transmitting audio signals via a wireless audio link;
at least one receiver unit for receiving audio signals from the transmission unit via the wireless audio link, the receiver unit comprising a speech quality indicator unit comprising means for assessing a speech quality of the received audio signals and means for providing a signal representative of an assessed speech quality;
means for stimulating a user's hearing according to the audio signals received by the receiver unit; and
means for providing an alarm signal if the assessed speech quality is below a predefined threshold value.

28. The system of claim 27, wherein the means for providing an alarm signal is part of the speech quality indicator unit.

29. The system of claim 28, wherein the receiver unit is adapted to provide the alarm signal to a user of the receiver unit.

30. The system of claim 29, wherein the alarm signal is an audio signal to be supplied to the stimulating means.

31. The system of claim 27, wherein the receiver unit is adapted to provide the alarm signal to a speaker using the transmission unit.

32. The system of claim 31, wherein the receiver unit comprises means for transmitting the alarm signal via a wireless data link to the transmission unit, the transmission unit comprising means for supplying an optical, acoustic or vibration signal to the speaker according to the received alarm signal.

33. The system of claim 27, wherein the receiver unit comprises means for transmitting the alarm signal via a wireless data link to a monitoring unit to be used by a system supervisor.

34. The system of claim 27, wherein the receiver unit comprises means for transmitting the alarm signal via a wireless data link to an interface of a communication network.

35. A hearing assistance system comprising
a transmission unit comprising a microphone arrangement for capturing audio signals from a speaker's voice and means for transmitting audio signals via a wireless audio link;
at least one receiver unit for receiving audio signals from the transmission unit via the wireless link;
means for stimulating a user's hearing according to the audio signals received by the receiver unit;
a speech quality indicator device (comprising means for receiving audio signals via the wireless audio link from the transmission unit and a speech quality indicator unit comprising means for assessing a speech quality of the received audio signals and means for providing a signal representative of an assessed speech quality.

36. The system of claim 35, wherein the means for providing a signal representative of the assessed speech quality is adapted to provide an alarm signal if the assessed speech quality is below a predefined a threshold value.

37. The system of claim 36, wherein the speech quality indicator device is adapted to provide the alarm signal as an optical signal.

38. The system of claim 36, wherein the speech quality indicator device is adapted to provide the alarm signal to a speaker using the transmission unit.

39. The system of claim 38, wherein the speech quality indicator device comprises means for transmitting the alarm signal via a wireless data link to the transmission unit, the transmission unit comprising means for supplying an optical, acoustic or vibration signal to the speaker according to the received alarm signal.

40. The system of claim 35, wherein the speech quality indicator device comprises means for transmitting the alarm signal via a wireless data link to a communication network.

41. The system of claim 35, wherein the speech quality indicator device comprises means for transmitting the alarm signal via a wired data link to a wire-based communication network.

42. A hearing assistance system comprising
a transmission unit comprising a microphone arrangement for capturing audio signals from a speaker's voice and means for transmitting audio signals via a wireless audio link;
at least one receiver unit for receiving audio signals from the transmission unit via the wireless audio link;
means for stimulating a user's hearing according to the audio signals received by the receiver unit;
wherein the transmission unit comprises a speech quality indicator unit comprising means for assessing a speech quality of the captured audio signals and means for providing a signal representative of an assessed speech quality.

43. The system of claim 42, wherein the means for providing a signal representative of the assessed speech quality is adapted to provide an alarm signal if the assessed speech quality is below a predefined a threshold value.

44. The system of claim 43, wherein the transmission unit is adapted to provide the alarm signal to a speaker using the transmission unit as at least one of an optical, acoustic and vibration signal.

45. The system of claim 43, wherein the transmission unit comprises means for transmitting the alarm signal via a wireless data link to a monitoring unit to be used by a system supervisor.

46. The system of claim 43, wherein the transmission unit comprises means for transmitting the alarm signal via a wireless data link to a communication network.

47. The system of claim 34, wherein the communication network is a network selected from the group consisting of WLAN, SMS, Bluetooth, ZigBee, DECT, Certified Wireless USB and ONE-NET system.

48. The system of claim 34, wherein the system comprises a plurality of transmission units forming the communication network, each adapted to be worn by a speaker and comprising a microphone arrangement for capturing audio signals from the speaker's voice, means for transmitting audio signals via a wireless audio link, an assistive digital link transceiver portion for establishing a bidirectional assistive digital link to at least one of at least one of the other transmission units and an external command unit, and a control unit for controlling audio signal transmission of the transmission unit according to data exchanged with at least one of the control unit of said at least one of the other transmission units and the external command unit, wherein audio signal transmission of said transmission units is controlled by communication of the control units via the assistive digital link in such a manner that at a time only one of the transmission units is allowed to transmit audio signals via the audio link.

49. The system of 48, wherein the receiver unit comprises an assistive digital link transceiver portion for establishing a bidirectional assistive digital link to at least one of at least one of the transmission units and an external command unit for transmission of the alarm signal.

50. The system of claim 46, wherein the system comprises a plurality of transmission units forming the communication network, each adapted to be worn by a speaker and comprising a microphone arrangement for capturing audio signals from the speaker's voice, means for transmitting audio signals via a wireless audio link, an assistive digital link transceiver portion for establishing a bidirectional assistive digital link to at least one of at least one of the other transmission units and an external command unit, and a control unit for controlling audio signal transmission of the transmission unit according to data exchanged with at least one of the control unit of said at least one of the other transmission units and the external command unit, wherein audio signal transmission of said transmission units is controlled by communication of the control units via the assistive digital link in such a manner that at a time only one of the transmission units is allowed to transmit audio signals via the audio link, and wherein each transmission unit comprises a speech quality indicator unit and means for transmitting the alarm signal via the bidirectional assistive digital link to at least one of at least one of the other transmission units and an external command unit.

51. The system of claim 40, wherein the system comprises a plurality of transmission units forming the communication network, each adapted to be worn by a speaker and comprising a microphone arrangement for capturing audio signals from the speaker's voice, means for transmitting audio signals via a wireless audio link, an assistive digital link transceiver portion for establishing a bidirectional assistive digital link to at least one of at least one of the other transmission units and an external command unit, and a control unit for controlling audio signal transmission of the transmission unit according to data exchanged with at least one of the control unit of said at least one of the other transmission units and the external command unit, wherein audio signal transmission of said transmission units is controlled by communication of the control units via the assistive digital link in such a manner that at a time only one of the transmission units is allowed to transmit audio signals via the audio link, and wherein the speech quality indicator device comprises an assistive digital link transceiver portion for establishing a bidirectional assistive digital link to at least one of at least one of the transmission units and an external command unit for transmission of the alarm signal.

52. The system of one claim 27, wherein the receiver unit is to be worn at or at least partly in the user's ear.

53. The system of claim 52, wherein the receiver unit is connected to a hearing aid (274), and wherein the hearing aid comprises the stimulation means.

54. The system of claim 27, wherein the transmission unit is adapted to be worn by the speaker.
